(19) United States
(12) Patent Application Publication
(10) Pub. No.: US 2025/0335845 A1
(43) Pub. Date: Oct. 30, 2025

(54) Demand Transference Machine Learning Model

(71) Applicant: Oracle International Corporation, Redwood Shores, CA (US)

(72) Inventors: Su-Ming WU, Waltham, MA (US); Deniz AFLAKI, Wexford, PA (US); Arian AFLAKI, Wexford, PA (US)

(21) Appl. No.: 19/186,737

(22) Filed: Apr. 23, 2025

Related U.S. Application Data
(60) Provisional application No. 63/637,963, filed on Apr. 24, 2024.

(51) Int. Cl. G06Q 10/0631; G06N 7/00; G06Q 30/0202

(52) U.S. Cl. CPC G06Q 10/06315; G06N 7/00; G06Q 30/0202; G06Q 30/0206

(57) ABSTRACT

Embodiments determine demand transference for an item assortment of a retailer. Embodiments receive historical sales data for a category of items corresponding to the retailer and receive hierarchy data for the category of items corresponding to the retailer. Based on the historical sales data and the hierarchy data, embodiments estimate first variables of a multinomial logit (“MNL”) model. Based on the historical sales data and the hierarchy data, embodiments estimate second variables of a log linear retail sales model.

### CROSS REFERENCE TO RELATED APPLICATIONS

This application claims priority to U.S. Provisional Patent Application Ser. No. 63/637,963 filed on Apr. 24, 2024, the disclosure of which is hereby incorporated by reference.

### FIELD

One embodiment is directed generally to a computer system, and in particular to computer system that generates and implements a machine learning model to predict demand transference.

### BACKGROUND INFORMATION

A standard task in the operations of almost all retailers is deciding what specific items each store should carry in a particular category and how to price them. For example, a typical supermarket may have hundreds of categories, among which could be a “yogurt” category. A category manager for the grocer must decide, for each store, which yogurt stock keeping units (“SKU”s) the store will carry. The category manager for the yogurt category periodically reviews the yogurt assortments at the stores of the grocer, and may both remove and add various yogurt SKUs to the assortments under review.

The goals of the category manager in adding and removing SKUs from the assortments can be many and varied, and will depend on the specific business objectives that the retailer has for each category that the retailer sells. However, regardless of the business objectives that a category manager has, to make reasonable changes to an assortment, the category manager usually needs to know the “demand transference” that will result from adding or removing SKUs from the assortment. These demand transference effects are a major consideration a manager would use in determining the additions and removals to perform.

Demand transference as applied to a retail store generally involves two types of effects: those resulting from the removal of an SKU from an assortment, and those resulting from the addition of a SKU to the assortment. Removing an SKU from a store's assortment will usually mean that some fraction of the customers who were purchasing that SKU will choose to purchase a similar SKU from the same store. Thus, a portion of the demand for the removed SKU transfers to the SKUs remaining in the assortment at the store. For example, in the yogurt category, if the category manager were to remove from the assortment the strawberry flavor of a particular brand of yogurt, many (but likely not all) consumers who were purchasing the removed yogurt could decide to purchase the strawberry flavor of another brand as a replacement. The replacement yogurt are in their minds similar enough to the removed yogurt that they are willing to switch instead of walking away from the store with no strawberry yogurt at all. Thus, the demand for the removed SKU consists of two parts: demand that will transfer to the remaining SKUs in the assortment, and lost demand, representing loss of demand from those shoppers who cannot find a SKU in the assortment that is similar enough to the removed SKU.

Conversely, suppose the category manager introduces a new SKU into the category's assortment at a store. Some shoppers at the store will switch from the SKU that they were already buying in the category to the newly-introduced SKU. Further, some shoppers at the store who never before bought any SKU of the category may start buying the new SKU. The demand for the new SKU thus consists of two parts: transferred demand from already existing SKUs in the category, and incremental new demand (or just incremental demand) from shoppers who were not already purchasing a SKU in the category.

Knowledge of these demand transference effects may influence a category manager's assortment decisions in the following ways: (1) The category manager may decide to remove a particular SKU because its lost demand will be small, meaning most shoppers will decide to switch to another SKU in the assortment; and (2) Given a possible set of SKUs to add to an assortment, the category manager may pick the one that will bring the most incremental demand to the category. The category manager may decide to avoid adding SKUs whose incremental demand is very small, reasoning that adding such a SKU will raise costs without bringing in much more revenue.

In addition to making decisions about assortments, retailers must also know the effects of price changes within an assortment, as price changes have effects similar to the ones described above for assortment changes. That is, demand transference is due to assortment changes and also to price changes. Increasing the price of an item will decrease demand for the item but also increase demand for other items in the assortment due to customers switching to the other items because of the price increase. Conversely, decreasing the price of an item increases its demand but also decreases the demand of other items as customers switch to purchasing the newly discounted item. These changes in demand for all of the items in the assortment affect retail operations in various ways. For example, the effects of price changes should cause the retailer to adjust orders for the various items in the assortment.

### SUMMARY

Embodiments determine demand transference for an item assortment of a retailer. Embodiments receive historical sales data for a category of items corresponding to the retailer and receive hierarchy data for the category of items corresponding to the retailer. Based on the historical sales data and the hierarchy data, embodiments estimate first variables of a multinomial logit (“MNL”) model. Based on the historical sales data and the hierarchy data, embodiments estimate second variables of a log linear retail sales model.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates an example of a system that includes a demand transference system in accordance to embodiments.

FIG. 2 is a block diagram of the demand transference system of FIG. 1 in the form of a computer server/system in accordance to an embodiment of the present invention.

FIG. 3 is a flow/block diagram of the functionality of the demand transference module of FIG. 2 for performing demand transference in accordance with an embodiment.

FIGS. 4-7 illustrate an example cloud infrastructure that can implement the cloud that includes demand transference system of FIG. 1 in accordance to embodiments.

### DETAILED DESCRIPTION

Many computer based systems determine demand transference for retailers as part of forecasting. As disclosed, demand transference is the effect of consumer demand moving from one item to another in response to price changes or item unavailability. For example, at a grocery store, if one SKU for milk goes up in price or is temporarily unavailable, customers will instead buy another milk SKU that is similar. Known computer systems use various statistical models to make predictions about the demand transference given historical sales data and information about future pricing and inventory availability.

Several varieties of known models are so-called empirical models. However, the nature of these models mean they can produce unexpected or unintuitive results, such as total assortment demand increasing when items are removed from the assortment. Retailers using these known systems that produce these erratic results have difficulty trusting such systems, therefore affecting the sales of such software systems. Many of these known systems are based on the “Scan*Pro” model or derivatives (i.e., any log-linear retail sales model). The Scan*Pro model is a store-level model used to quantify the effects of promotional activities on a brand's unit sales, requiring store-level data on weekly brand sales and in-store promotional activity for estimation.

In contrast, embodiments are directed to a demand transference prediction model that uses a dual layer machine learning model. Embodiments avoid several of the unexpected results of the Scan*Pro system while leaving a substantial portion of Scan*Pro in place. Embodiments can be implemented as an addition to Scan*Pro systems instead of being a wholesale replacement.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

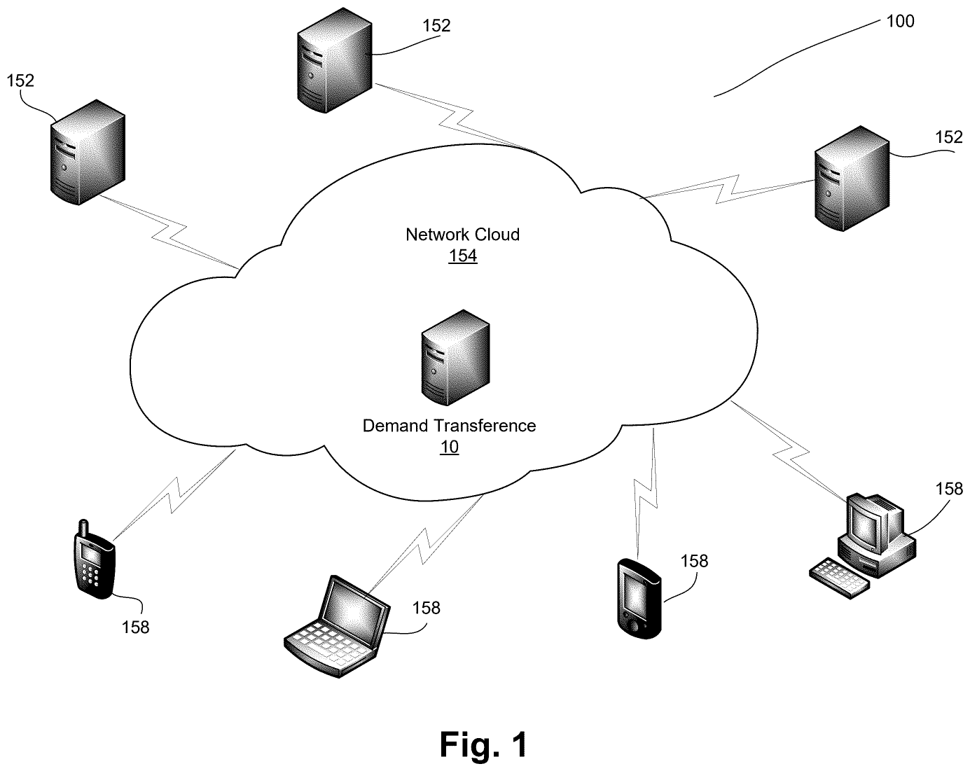

FIG. 1 illustrates an example of a system 100 that includes a demand transference system 10 in accordance to embodiments. Demand transference system 10 may be implemented within a computing environment that includes a communication network/cloud 154. Network 154 may be a private network that can communicate with a public network (e.g., the Internet) to access additional services 152 provided by a cloud services provider. Examples of communication networks include a mobile network, a wireless network, a cellular network, a local area network (“LAN”), a wide area network (“WAN”), other wireless communication networks, or combinations of these and other networks. Demand transference system 10 may be administered by a service provider, such as via the Oracle Cloud Infrastructure (“OCI”) from Oracle Corp.

Tenants of the cloud services provider can be companies or any type of organization or groups whose members include users of services offered by the service provider. Services may include or be provided as access to, without limitation, an application, a resource, a file, a document, data, media, or combinations thereof. Users may have individual accounts with the service provider and organizations may have enterprise accounts with the service provider, where an enterprise account encompasses or aggregates a number of individual user accounts.

System 100 further includes client devices 158, which can be any type of device that can access network 154 and can obtain the benefits of the functionality of demand transference system 10 of predicting demand transference for a retail assortment. As disclosed herein, a “client” (also disclosed as a “client system” or a “client device”) may be a device or an application executing on a device. System 100 includes a number of different types of client devices 158 that each is able to communicate with network 154.

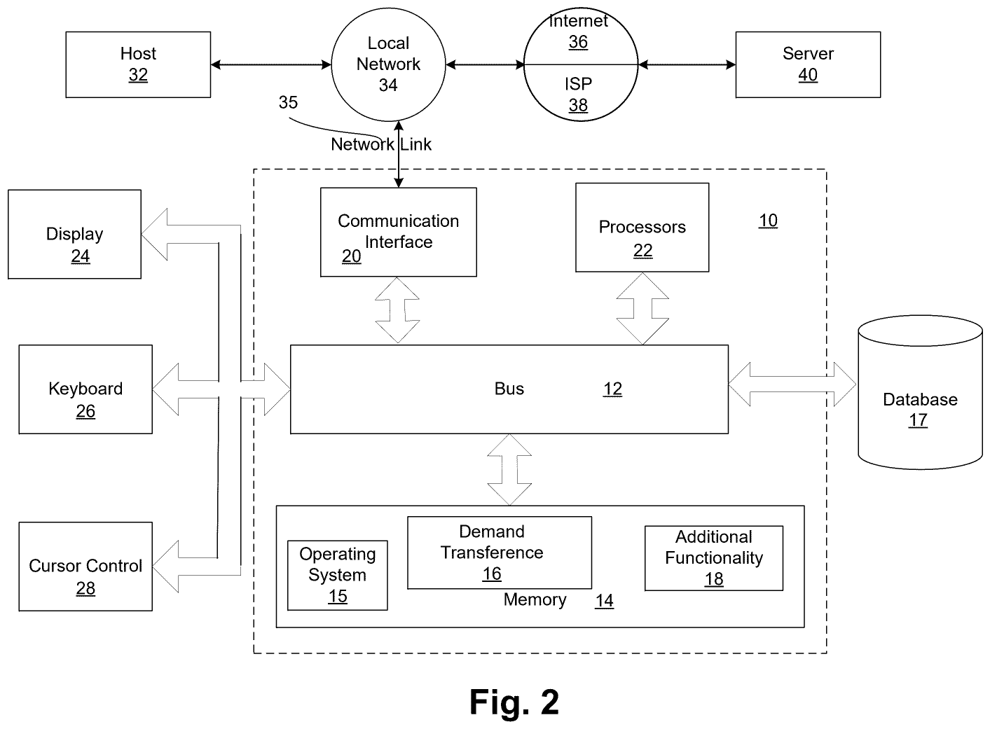

FIG. 2 is a block diagram of demand transference system 10 of FIG. 1 in the form of a computer server/system 10 in accordance to an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. One or more components of FIG. 2 can also be used to implement any of the elements of FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication interface 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, transitory and non-transitory media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include a demand transference module 16 that predicts demand transference for a retail assortment, and all other functionality disclosed herein. System 10 can be part of a larger system that utilizes the demand transference functionality. Therefore, system 10 can include one or more additional functional modules 18, such as an automated inventory management application (e.g., “Inventory Optimization” from Oracle Corp.), an assortment planning application (e.g., “Retail Assortment Planning” from Oracle Corp.), or an overall retail application such as “Oracle Cloud for Retail” from Oracle Corp. A file storage device or database 17 is coupled to bus 12 to provide centralized storage for modules 16 and 18, including training data (i.e., historical sales data) that is used by the models. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 10, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

Retailers rely on forecasts for various purposes, such as planning and inventory replenishment. Forecasts should account for demand transference, meaning consumer demand moving from one item to another in response to price changes or item unavailability. As disclosed, known system for producing such forecasts for retailers can rely on a wide variety of statistical models. The models relate sales-units volume to various factors that almost always including price and item availability. The models employ mathematical functions that relate the factors to sales units. The known models fall into two broad classes depending on the nature of the function:

1) Empirical models: The functions in these known models are not based on a theory of consumer behavior, but instead are chosen as best approximations to predicting sales units. The approximations can produce unexpected results due to being approximations. On the positive side, these models are typically much easier to implement, and it is relatively easy to keep adding more factors to refine their accuracy. Scan*Pro is one of the oldest and most widely used such model.

2) Models based on a theory of consumer behavior: These known models account for the movement of individual sales units from item to item by specifying how consumers behave under the influence of the factors. These models are frequently more difficult to implement because they require non-standard “estimation” (described below). It can also more difficult to add additional factors to them. On the positive side, by their nature they do not produce unexpected results.

Model “estimation” is the process of fitting the model to historical data, by finding the values of a model's parameters that best explain observed data, using statistical analysis techniques. Both types of the above models require such fitting (i.e., machine learning model “learning”/“training”). Because of the typical large volume of retail data, simpler estimation processes have an advantage since they minimize compute resources, and so known commercial software systems for forecasting have frequently favored empirical models. It is also typically simpler to add additional factors to empirical models, which is important for known forecasting systems since clients frequently want to add various additional factors to the forecast. It can be difficult to add factors to models based on a theory of consumer behavior because the theory underlying the model may not allow adding such factors.

### Scan*Pro Model

As disclosed, in its usual form, the Scan*Pro model and all other derivative log linear retail models can give extreme and unrealistic behavior. For example, in a Scan*Pro model that includes cross-price effects, raising the price of one item arbitrarily high can cause the demand for another item to increase without bound. Further, in a Scan*Pro model that includes assortment effects, the removal of various items from the assortment results in total demand of the remaining items being larger than before the removal of the items. Such unrealistic behavior is noteworthy because it can lead to unrealistic solutions when using these models to perform demand or revenue maximization. In practice, such unrealistic solutions might be avoided by adding constraints or regularization terms. In contrast, instead of such an ad hoc approach, embodiments implement a modified/derived version of Scan*Pro that inherently is less subject to such unrealistic behavior.

### Example of Unrealistic Behavior

As an example of unrealistic behavior of the Scan*Pro model and derivatives, consider a version of Scan*Pro that includes only price effects. Given a set of items i=1 . . . N, the sales-units rate Sᵢ of item i is:

$${S}_{i} = {B}_{i} {\prod }_{j = 1}^{N} {p}_{j}^{{γ}_{ij}}$$

Each pᵢ is the price of item i and Bᵢ is the base sales rate of the item i. The γᵢⱼ, i≠j, are the cross elasticities, and represent the effect on demand of item i of the price of item j. When i=j, γᵢⱼ is a self elasticity. The examples also use the following standard assumptions on the elasticities:

$${γ}_{ii} < - 1$$

$${γ}_{ij} \geq 0 , i \neq j$$

### Unbounded Sᵢ and Unbounded Total Revenue

Choose a γᵢⱼ>0. As pⱼ increases without bound, so does Sᵢ since γᵢⱼ>0. Sᵢ increasing without bound is already unrealistic, but note in addition that simultaneously Sⱼ goes to 0 since γⱼⱼ<0. Therefore, as pⱼ increases, the model is eventually transferring to item i more sales than item j had. Further, the revenue pᵢSᵢ goes to infinity as pⱼ→∞ since Sᵢ increases without bound while pᵢ remains constant.

### Increased Total Sales

Because the Scan*Pro model is eventually transferring to item i more sales than item j had, the total sales ΣᵢSᵢ increases even though pⱼ increases. A more detailed examination of this phenomenon shows it is due to Scan*Pro being a constant-elasticity model. Suppose price pⱼ is increased by multiplying by the factor m>1, with no other prices being altered. Let

$${S}_{i}^{-}$$

denote the sales units of item i before the alteration of pⱼ, and let

$${S}_{i}^{+}$$

denote the sales units after the alteration. Then

$${S}_{i}^{+} / {S}_{i}^{-} = {m}^{{γ}_{ij}} .$$

This factor represents the transference of demand from item j to item i. That is, some of the customers who were buying item j will instead buy the substitute i. But the factor m^{γij} does not depend on either Sᵢ or Sⱼ, and so the model may predict an increase in Sᵢ that is larger than the decrease in Sⱼ. For example, in the worst case, the increase

$${S}_{i}^{+} - {S}_{i}^{-}$$

may be larger than the entire amount Sⱼ.

Therefore, the reliance on empirical models, particularly the Scan*Pro model and other related log linear retail sales models, means that predictions from the empirical model may contradict common sense. For example, it is possible for removing items from an assortment to cause in the empirical model an overall increase in the predicted sales of the assortment. This does not occur with models based on a theory of consumer behavior. Commonly the explanation for the counter-intuitive results is that the empirical model is being used in a regime where it does not apply, such as excessively low or high prices. Thus one ad hoc solution has been to restrict regimes of price or assortment to a narrow range. Unfortunately, this is frequently not enough, and so known solutions use “guard rails” that simply check for counter-intuitive results and makes ad hoc modifications to them to avoid showing them to the retailer. These known ad hoc solutions are frequently difficult to derive because they handle only specific instances of the difficulty and their consequences on other cases may not be obvious. Further, it is always possible that they themselves introduce other unexpected results.

Seeing such unintuitive results naturally decreases the retailers' confidence in the forecasts, and also results in the application vendor having to spend additional time in explaining the results and also in implementing further ad hoc code modifications.

In contrast to known solutions for determining demand transference, embodiments provide an additional model layer on top of a modified Scan*Pro model, or any similar log linear retail sales models, instead of using a disparate collection of ad hoc tricks. Embodiments can provide a mathematical guarantee that the total sales of the entire assortment does not increase when removing items from the assortment. Unlike ad hoc approaches, the guarantee does not require that estimated parameters stay within a pre-specified range other than the specifications that all Scan*Pro models must adhere to, making the system easier to implement. The guarantee is thus absolute, rather than the piecemeal guarantees that are typically the best that ad hoc solutions can offer. The additional model layer in embodiments is a Multinomial Logit (“MNL”) model. An MNL model is a statistical model used to predict the probability of a categorical outcome with more than two categories, where the outcome categories have no inherent order, based on a set of predictor variables.

Embodiments modify the underlying Scan*Pro model (i.e., generate a model derived from the Scan*Pro model), or other known derivative log linear retail sales model based layer. However, estimating this modified Scan*Pro can use the same traditional techniques as estimating the original unmodified Scan*Pro. In embodiments, the estimation of the modified Scan*Pro is not more difficult than estimating Scan*Pro itself, which is not true for models based on a theory of consumer behavior. Specifically, as disclosed below, the ratio-of-pairs method and the geometric-mean method in embodiments is used to estimate the modified Scan*Pro lower-layer model. Those methods produce log-linear models, and Scan*Pro is also a log-linear model. Therefore, in embodiments, the same estimating methods used for the modified Scan*Pro can be used for systems that use the original Scan*Pro model and its equivalents. Therefore, in embodiments, the lower-layer model is no more difficult to estimate than the original Scan*Pro, which provides technical advantages.

In embodiments, the estimation of the new MNL-based layer also implements known established techniques. In particular, one embodiment implements the “simplest” type of MNL model (i.e., non-nested), with known estimating techniques, therefore avoiding the use of nested-MNL models, which require more complex estimation.

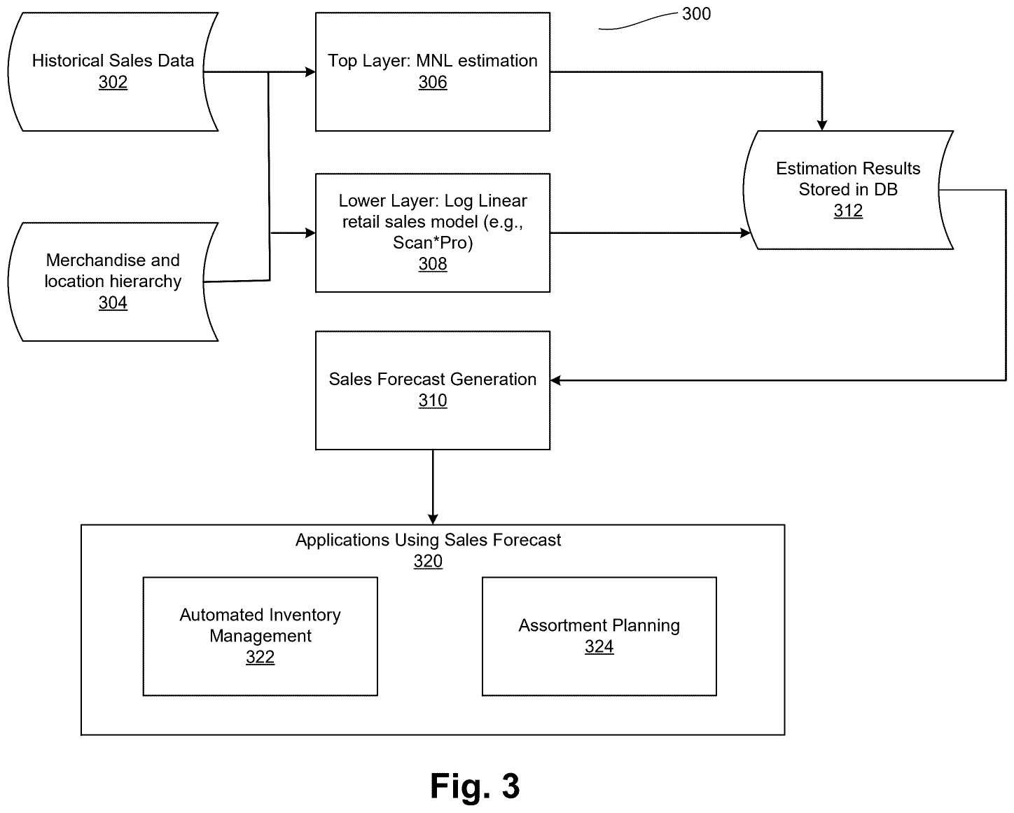

FIG. 3 is a flow/block diagram of the functionality of demand transference module 16 of FIG. 2 for performing demand transference in accordance with an embodiment. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

Embodiments receive, as input data, historical sales data at 302. In embodiments, the retailer's historical sales data is stored in a database. In embodiments that interface with “Oracle Cloud for Retail” from Oracle Corp., the historical sales data is stored on an Oracle autonomous database. The historical sales data in embodiments is from a single category (e.g., yogurt or coffee category), and is typically from multiple retail stores, but can be from a single store. In embodiments, at least two years of data is used so that seasonality can be determined.

Embodiments further receive, as input data, hierarchy data at 304. The hierarchy data is the retailer's merchandise hierarchy and location hierarchy, and is determined and stored in most or all commercial retail software systems. The merchandise hierarchy data generally classifies products into different levels, such as departments, categories, subcategories, and individual items. The location hierarchy data generally organizes stores, distribution centers, and customers into a tree-like structure, enabling planning, logistics, reporting, and demand forecasting by grouping locations based on various criteria like geography or customer type.

Embodiments include an MNL layer 306, or “top layer”. MNL layer 306 reads input data 302, 304, performs aggregation to the category level, and then determines values for the parameters (i.e., estimation) that form the MNL model, denoted as M, γ_{Tj}, and B_{Tj}, which are disclosed as follows: Denote the set of all potential customers who might consider purchasing an item in N by [symbol] , where M=| [symbol] | is the size of this market. γ_{Tj} is typically known as “price elasticity”, as it relates the price of an item to its sales. B_{Tj} is the “base utility” of an item, meaning how valuable is it to the market if its price were 0. MNL layer 306 estimates the values of these parameters at the category level of merchandise, which is the level that collects together similar merchandise, merchandise similar enough that customers may substitute one for the other when making a choice. For example, milk is a category and bread is a category, and MNL estimation is performed separately for each. MNL layer 306 then writes its results back to the database at 312.

Embodiments include a log linear retail sales model layer 308 or “lower layer” (e.g., the Scan*Pro model). Layer 308 reads in the historical data 302, 304 as-is, without aggregation and is used to construct shares. Typically this is the SKU-store level. Layer 308 determines/estimates the values for the variable that form the log linear retail sales model denoted as Bᵢ, γᵢⱼ, and αᵢⱼ, which are disclosed as follows: Bᵢ is the “base demand” of item i, meaning its sales in an assortment where it is the only item and where its price is $1. γᵢₜ is the “self-price elasticity” of item i, giving the relationship between the item's price and its sales. Yᵢⱼ, i≠j is the “cross-price elasticity” between item i and item j, and represents the effect on sales of i if the price of j changes (causing customers to switch from j to i or vice versa). αᵢⱼ, is the “assortment effect” of j on i, meaning how much j takes from the sales of i just by being in the same assortment. Separate sets of such values are calculated for each category using only the SKUs specific to each category. Therefore, while the data is SKU-store level, the data is pooled by category for the determinations at layer 308. At 312, layer 308 writes these calculated values back to the database.

In embodiments, layers 306 and 308 perform independent calculations/estimations, as shown as the two separate branches in FIG. 3. Due to the independence, it is possible for the two calculations to proceed in parallel. In embodiments, an existing forecasting system may already have a layer based on Scan*Pro or equivalent log linear retail sales model 308, since Scan*Pro and Scan*Pro-like systems are very common. For example, the forecasting system used by “Oracle Retail” uses a pre-existing Scan*Pro-type model. If an existing system is already based on the Scan*Pro model or equivalent, embodiments are able to re-use the existing Scan*Pro layer as layer 308, meaning using the existing output as-is, with a revised estimation method (e.g., the ratio-of-pairs method or the geometric-mean method disclosed below). In these embodiments, the branch at 308 is the existing Scan*Pro layer or the equivalent.

After the estimation of both layers 306, 308 has been performed, the determined values of the parameters are sent to a forecasting module which predicts the effects of known future price changes and future assortment changes on sales. The sales predictions go to other modules such as “Inventory Optimization” from Oracle Corp., which is a module that automatically places orders for the items in an assortment. For example, if the retailer is removing an item in the future, the forecasts for the other items in the assortment will increase somewhat and Inventory Optimization will order somewhat more of the other items. Similar actions take place for future price changes. Typically, the modules such as Inventory Optimization are separate from the system which performs the estimation and forecast generation. A module known as “Assortment Planning” from Oracle Corp. may also use the estimates. In Assortment Planning, users ask “what-if” questions, such as what happens to sales of other items if various items added/removed or have their prices changed. The lower-layer model and top-layer model and the associated estimates are loaded into the Assortment Planning module to enable it to generate what-if results for the user. The user applies the what-if results to decide on the assortment that the retailer will carry in the future. The decisions go to an order management system to place initial orders for the merchandise in the assortment.

In embodiments, the generated parameters of the models 306, 308 are not used by themselves but are rather used to generate a forecast or what-if results in other modules. However, embodiments can use the values of the parameters themselves to serve as a qualitative guide for retailers. One example is for the question of whether the retailer should lower the price of a particular item i to increase its sales. The estimated values γⱼᵢ, i≠j, may be large enough to indicate that lowering the price of i will possibly take sales away from many other items and therefore lowering the price of i may not be worth doing or at least that caution is warranted. Such qualitative judgements may be valuable to retailers who are less automated and where software systems for inventory management or assortment planning are less pervasive.

At 310, a sales forecast is generated using the determined variables (i.e., estimated values) from 306 and 308. In embodiments, any known sales forecast-generation module can be modified to use both the MNL layer 306 and also use the log linear retail sales model layer 308 outputs in accordance with the invention. In one embodiment, the sales forecast module at 310 is implemented using “Retail Demand Forecasting Cloud Service” from Oracle. In other embodiments, any known sales forecast solution can be used. However, in embodiments, the sales forecast module at 310 calculates SKU-store shares rather than absolute SKU-store sales values.

In other embodiments, instead of a separate sales forecast module, the values of the estimated parameters can plugged into upper layer 306 and lower layer 308 models and the arithmetic that the models specify can be performed, provided that future prices and future assortments are known. That is, the retailer knows what future price changes might be, at least in the short term, and similarly for assortment changes. Then it is a matter of “running the model” in the sales forecasting system, that is, plugging in the estimated parameter values along with the future price changes and future assortment changes to see what sales for all items will be. Since future price changes and future assortment changes could vary by store, the forecast is actually at the sku-store-week level.

After generating the sales forecast at 310, embodiments utilize the sales forecast for one or more practical applications at 320. For example, at 322, the sales forecast are used with an automated inventory-management systems, such as Oracle's “Inventory Planning and Optimization” from Oracle Corp., or with an assortment-planning systems, such as Oracle's “Assortment Planning” from Oracle Corp. For the automated inventory-management systems, resulting movement of inventory between stores, or between warehouses and stores, may be fully automated by using IoT or other sensors to track, and automated moving systems or vehicles to move the inventory.

### Overall Model Description

For the purpose of describing the overall model/system 300 shown in FIG. 3, in accordance to embodiments, let N={1,2, . . . , n} be the set of all products and pᵢ denote the price of item i∈N with p=(p₁, . . . , Pₙ) being the vector of prices. Let A⊂N be the selling assortment. Denote the set of all potential customers who might consider purchasing an item in N by [symbol] , where M=| [symbol] M | is the size of this market. For the moment, suppose A and M do not vary with time. The definition of the model proceeds in two steps: (1) defining how much of the market a retailer captures with a given set of prices and a given assortment; and then (2) of the market so captured, what share of that goes to each item in a particular store. In the end, the two steps give item-level forecasts by multiplying the shares in (2) by M times the fraction of the market given by (1).

While the two steps together form a single model that gives item-store level forecasts, for ease of explanation the single model is separated into two models, namely top-layer model 306 for (1) and lower-layer model 308 for (2).

### Top-Layer Model 306: The Total Demand, Based on Combined Utility

Embodiments consider the overall attractiveness of A offered at price p as the combined utility of the entire assortment as whole, denoted by U_{T}(p, A). For example, consider a one-product MNL model where the single product is the assortment A, and purchase of this single product means purchasing an item from A. Then the associated utility function for this single product is:

$${U}_{T} ( p , A ) = {B}_{T} {\sum }_{j ∈ A} {e}^{{γ}_{Tj} {p}_{j}}$$

where γ_{Tj}≤0. The attractiveness U_{T}(p, A) of assortment A is non-increasing with increasing prices. It also decreases with removal of items from the assortment because the sum has fewer terms each of which is positive. B_{T} is the intercept for the utility.

Based on combined utility U_{T}(p, A), a fraction α(U_{T}(p, A)) of [symbol] purchase an item in A. The function α(·): R⁺→[0,1) is the market share of the retailer because it translates the combined utility U_{T} into a fraction. Finally, the total demand for A is given by:

$${D}_{T} ( p , A ) ≡ α ( {U}_{T} ( p , A ) ) M .$$

To be meaningful, α(·) must be a proper share function. α(·) is a proper share function if it is increasing in x with lim_{x→0}α(x)=0, lim_{x→∞}α(x)=1.

Example. α(x)=x/(1+x) is a proper share function.

### Lower-Layer Model 308: the Demand for Each Item

The total demand D_{T}(p, A) represents those in [symbol] who have decided to purchase one unit from A. How is that total demand partitioned among the products in A? For Product i, price vector p and assortment A induces attractiveness log(uᵢ(p, A)) for some utility functions uᵢ(p, A)). Now define the share sᵢ(p, A) of D_{T}(p, A) purchasing Item i to be:

$${s}_{i} ( p , A ) = \frac{{u}_{i} ( p , A )}{{\sum }_{j ∈ A} {u}_{j} ( p , A )} .$$

This function is often referred to as “soft-max” and is common in machine learning. This function also arises in Multinomial Logit (“MNL”) choice problems when the random parts of the customer utilities follow independent Gumbel distributions. In MNL models, the independence between the random terms results in unrealistic properties, such as the independence of irrelevant alternatives (“IIA”). Embodiments, however, do not rely on random utility models and capture the nuances of correlation between items through functions uᵢ(p). In other words, embodiments take any metric for the level of attractiveness of the products (denoted by uᵢ(p, A)) as inputs and translates them into demand shares.

Unlike in the formulas for shares in MNL models, the denominator of sᵢ(p, A) does not have a term for the no-purchase option because sᵢ(p, A) is the share of those customers who have already decided to purchase from A. The total demand D_{T}(p, A) is the part of this model that accounts for the possibility of no-purchase and so therefore the sᵢ (p, A) do not also need to account for no-purchase. Another way to say this is Σ_{i∈A}sᵢ(p, A)=1.

Aligned with Scan*Pro demand functions, embodiments define:

$${u}_{i} ( p , A ) ≡ {B}_{i} {\prod }_{j ∈ A} {p}_{j}^{{γ}_{ij}} {\prod }_{j ∈ A ∖ i} {α}_{ij}$$

subject to the standard constraints γᵢᵢ<−1, γᵢⱼ≥0 for j≠i, and aᵢⱼ∈(0,1]. Then the demand of Item i in assortment A is given by

$${D}_{i} ( p , A ) ≡ {D}_{T} ( p , A ) {s}_{i} ( p , A ) .$$

As with the combined utility U_{T}, uᵢ(p, A) accounts for price effects and assortment effects. As for price effects, it accounts for both self-price effects and cross-price effects. By construction, Σ_{i∈A D}ᵢ(p, A)=D_{T}(p, A).

Embodiments have similarities to the Nested Logit (“NL”) choice models, where customers first choose a nest (a category of products) and then maximize their utility by choosing an item from a nest. While the nests are independent, the products in each nest could be correlated. This approach solves the problem with the IIA in each category, but it has drawbacks. First, the IIA property is still present in the problem of choosing among the nests. Second, an empirical validation of this model requires proper division of the items into various nests.

If embodiments are interpreted in the language of NL models, customers first choose between the assortment offered by the firm and not purchasing anything. D_{T}(p, A) of the customers choose to purchase. Those who choose to purchase then select among the products offered in the assortment. However, because embodiments do not rely on random utility models, it avoids the drawbacks disclosed above.

Therefore all effects of the no-purchase option in embodiments are reflected in D_{T}(p, A) and none in the item demands Dᵢ(p, A). An increase in price pᵢ or removal of i from A has two results in embodiments: (1) some customers choose the no-purchase option; (2) the rest of the customers substitute, reflected in the parameters γᵢᵢ, γⱼᵢ, j≠i, and αⱼᵢ.

### Alternative Formula For Combined Utility

First alternative for the combined utility U_{T}(p, A):

$${\sum }_{j ∈ A} {e}^{{B}_{Tj} - {p}_{j} {γ}_{Tj}}$$

This is the standard MNL treatment of the assortment A, except that all that is necessary for embodiments is the sum of the shares of all items since the total demand of all items together is all that is needed. In this formulation, it is not necessary to have terms that denote the presence of an item j in the assortment A because the usual trick of setting the price pⱼ to infinity will remove item j from the above sum.

Second alternative for the combined utility:

$${\sum }_{j ∈ A} {e}^{{B}_{T} - {p}_{j} {γ}_{Tj}}$$

This is very similar to the first alternative except that instead of a base utility per item B_{Tj} it has just a single average base utility B_{T} for all items, greatly reducing the number of parameters to estimate. Since embodiments only care about the total utility, a single B_{T} is likely enough. Numerical experiments give evidence that a single B_{T} is sufficient when the number of items is large (in the hundreds).

Third alternative for the combined utility:

$$exp ( {B}_{T} + {\sum }_{j ∈ A} {p}_{j} {γ}_{Tj} + {\sum }_{j ∈ A} {α}_{Tj} )$$

This formulation is also an MNL formulation, but it considers the entire assortment A as a single item. “Purchasing” this single item then means “buying an item from the assortment.” The formulation requires additional parameters α_{Tj} to denote the presence/removal of items from the assortment because we can no longer set the price pⱼ to infinity as that would make the entire combined utility just be 0.

Fourth alternative for the combined utility:

In one embodiment, the following formula is used for the total demand

$${D}_{t}^{T} ( p , {A}_{t} )$$

itself, all in a single formula, instead of first defining a combined utility:

$${D}_{t}^{T} ( p , {A}_{t} ) = {B}_{T} {\prod }_{i ∈ {A}_{t}} {( \frac{{p}_{i}}{1 + {p}_{i}} )}^{{γ}_{Ti}}$$

This is not based on MNL theory but is instead a separate empirical model for

$${D}_{t}^{T} ( p , {A}_{t} ) .$$

Its advantage over MNL models is that logs can be taken and again have a log-linear model to estimate but at the expense of giving up the established theory of MNL models. Note that it has the same parameters, B_{T} and γ_{T}_{ᵢ}, as the MNL models.

### Alternative Formula For Item Utility

The item utility uᵢ(p, A) has an alternative formulation:

$${u}_{i} ( p , A ) = {B}_{i} {\prod }_{j ∈ A} {p}_{j}^{{γ}_{ij}} {\prod }_{j ∈ A} {α}_{ij}$$

This formulation multiplies in factors αᵢⱼ denoting the effect on item i of the presence of item j in the assortment irrespective of the price of j. Removal of item j from the assortment then means uᵢ(p, A) no longer has the factors pⱼ^{γ}ᵢⱼ and αᵢⱼ. Without the αᵢⱼ it may be more likely that removal of item j can actually decrease utility uᵢ(p, A) when it should increase. However, in embodiments it may not be worth adding so many additional parameters αᵢⱼ to avoid this.

### Properties of the Demand Function and Revenue Function

Define the firm revenue as

$$R ( p , A ) ≡ {\sum }_{j = 1}^{n} {R}_{i} ( p , A ) ,$$

where Rᵢ(p, A)=pᵢ×Dᵢ(p, A) is the revenue from selling Product i in assortment A at price pᵢ. The following are natural preliminaries that would be needed for any regular demand model, and also show that the model in accordance to embodiments avoids the problems in disclosed above in connection with the Scan*Pro model.

Dᵢ(p, A) and Rᵢ(p, A) have the following properties:
(i) Demand of Item i. Dᵢ(p, A), decreases with increasing pᵢ.
(ii) The total demand D_{T}(p, A) is non-increasing in pⱼ for any j∈A.
(iii) limₚ_{ᵢ}_{→0}Rᵢ(p, A)=0, limₚ_{ᵢ}_{→∞}Rᵢ(p, A)=0, and limₚ_{ᵢ}_{→∞}Rⱼ(p, A)<∞ for j≠i.

For (i), note sᵢ(p, A) decreases as pᵢ increases because uᵢ(p, A) decreases as pᵢ increases and uⱼ(p, A), j≠i, are non-decreasing as pᵢ increases. All of these are due to the constraints on γᵢⱼ. Also, the combined utility U_{T}(p, A) is non-increasing as pi increases due to the assumptions on γ_{Tj}.

The second property (ii) is an immediate consequence of the restrictions γ_{Tj}≤50. As a result, the problems disclosed above in connection with the Scan*Pro model cannot occur since the total demand cannot increase for any price increases.

For (iii), limₚ_{_{i→0}}Rᵢ(p, A)=0 because Dᵢ(p, A) can never be more than M, and so Rᵢ(p, A)≤pᵢM which is 0 if pᵢ=0. Similarly, Dᵢ(p, A) can never be more than M regardless of what pᵢ is, and so Rⱼ(p, A)=pⱼDⱼ(p, A) is finite even if pᵢ→∞.

For limₚ_{ᵢ}_{→∞}Rᵢ(p, A)=0, use the condition γᵢᵢ<−1. First, U_{T}(p, A) goes to a finite limit as pᵢ→∞ because γ_{T}_{ᵢ}<0, and therefore D_{T}(p, A) also goes to a finite limit. So what is the behavior of sᵢ(p, A) as pᵢ→∞? The denominator of sᵢ(p, A) goes to infinity, but perhaps at a sub-linear rate since all that is known is γⱼᵢ≥0 and so the γⱼᵢ may be very small. If γᵢᵢ<−1, then pi times the numerator of sᵢ(p, A) goes to 0 as pᵢ→∞, and therefore limₚ_{ᵢ}_{→∞}Rᵢ(p, A)=0.

However, if instead of using D_{T}(p, A) to implement the effect of the no-purchase option, assume the no-purchase option were directly reflected in sᵢ(p, A) by adding 1 to its denominator, mimicking standard MNL models. The problem is that (ii) might no longer be true due to the cross effects γᵢⱼ and αᵢⱼ. If pⱼ increases or if item j is no longer in A, then sⱼ(p, A) decreases or is 0, respectively, just as expected. But in addition, for other items i, uᵢ(p, A), i≠j, may increase, and increase enough that the share of the no-purchase option shrinks even though sⱼ(p, A) decreases. The no-purchase option shrinking means (ii) is untrue. Therefore, it is necessary to explicitly introduce D_{T}(p, A) to reflect the effect of the no-purchase option.

On the other hand, introducing D_{T}(p, A) does not fix all of the limitations of Scan*Pro. If pⱼ increases, then ideally sᵢ(p, A), i≠j, increases as expected, but even if it does, since D_{T}(p, A) decreases, it is possible that demand for some i, D_{T}(p, A)sᵢ(p, A), actually decreases. Whereas a model based on an economic theory of consumer behavior might predict that Dᵢ(p, A) never decreases but can only increase (due to some customers substituting j for i).

### Varying A and M

In estimating model 300 in accordance to embodiments, or in using the model for prediction, typically A and M will vary in time and also across stores. Retailers may vary assortments quite frequently in time and across stores. M typically changes in time because of seasonality, and it can vary across stores because of the characteristics of the store, such as where it is located. Note such considerations for M and for assortments also apply to MNL models. Thus, in estimation or in prediction, A must be replaced with Aₜₛ and M with Mₜₛ, the subscripts denoting week t and store s. To minimize notation for the purposes of this disclosure, store and week subscripts are applied only where necessary.

### Estimation Procedure

Model 300 in accordance to embodiments requires two separate estimations: one for lower layer model 308 and one for top layer model 306.

### Estimating Lower Layer Model 308 Using Ratio-of Pairs

Note that for each j∈A, the set {γᵢⱼ|i∈N} is only determined up to an additive constant. That is, for a given j∈A, adding a constant kⱼ to all γᵢⱼ multiplies all uᵢ(p, A) by the factor

$${p}_{j}^{{k}_{j}} .$$

The factor cancels out in the formula for sᵢ(p, A) leaving it unchanged. Thus, in lower layer model 308, for a given j E A, only the differences between γᵢⱼ and γⱼⱼ matter, and estimation should only produce estimates for these differences and not for the γᵢⱼ themselves. Consider the following 3-product illustration of how these differences operate in this model. Suppose γ₁₁=2, and γ₂₁=γ₃₁=5. Increasing p₁ still means the share s₁(p, A) decreases because u₂ and u₃ increase faster than u₁, thus driving down the share of product 1 even though γ₁₁ has the wrong sign. In fact this set of gammas is equivalent to γ₁₁=−1, γ₂₁=2, γ₃₁=2, and thus γ₁₁ can be made negative while γ₂₁ and γ₃₁ stay positive.

In embodiments, the “modified” or “derived” Scan*Pro model 308 is the share model sᵢ(p, A) disclosed above. This is referred to as a “modified” or “derived” Scan*Pro model because the formula for the shares sᵢ(p, A) uses the Scan*Pro formulas (i.e., the formula for the shares sᵢ(p, A) is derived from Scan*Pro).

A similar argument with the Bi also shows estimation can only estimate the ratios Bᵢ/Bⱼ, since multiplying all the Bᵢ by a constant also does not change the shares sᵢ(p, A).

Finally, multiplying all of the αᵢⱼ by any constant k multiplies each uᵢ(p, A) by k^{|A|-1}, which cancels out in sᵢ(p, A) leaving it unchanged (|A| denotes the number of items in assortment A). Note that multiplying only the aᵢⱼ for a specific j by a constant does not cancel out in sᵢ(p, A) because unlike with the gammas there is no αⱼⱼ in uⱼ(p, A).

Let N be the set of items that appear in the historical data and qᵢₜ are sales for item i∈N at week t at one particular store. Assume assortment information Aₜ is also available for this particular store. To minimize notation, the estimation procedure uses only one store, but estimating over many stores is only a matter of duplicating the construction over all of the stores. Similarly, the construction leaves out the t subscript, with the understanding that the construction is performed separately for each t as well as for each store.

The first step is to cancel out D_{T}(p, A) and also the denominator of sᵢ(p, A). For each pair of items m, k∈A, form the quotients:

$$\begin{matrix}\frac{{q}_{m}}{{q}_{k}} & = \frac{{D}_{T} ( p , A ) {s}_{m} ( p , A )}{{D}_{T} ( p , A ) {s}_{k} ( p , A )} \\ & = \frac{{B}_{m}}{{B}_{k}} {\prod }_{j ∈ A} {p}_{j}^{( {γ}_{mj} - {γ}_{kj} )} \frac{{\prod }_{j ∈ A ∖ m} {α}_{mj}}{{\prod }_{j ∈ A ∖ k} {α}_{kj}}\end{matrix}$$

Taking logs then gives:

$$log {q}_{m} - log {q}_{k} = log {B}_{m} - log {B}_{k} + {\sum }_{j ∈ A} ( {γ}_{mj} - {γ}_{kj} ) log ( {p}_{j} ) + {\sum }_{j ∈ A ∖ m} log {α}_{mj} - {\sum }_{j ∈ A ∖ k} log {α}_{kj}$$

Embodiments cannot perform least squares on this system as-is, since as discussed above, multiple solutions for the γᵢⱼ, for the log Bᵢ, and for the αᵢⱼ give the same value for the least-squares objective. Therefore, embodiments introduce constraints, for example:

$${\sum }_{k ∈ N} {γ}_{kj} = 0 , for each j ∈ N$$

$${\sum }_{k ∈ N} log {B}_{k} = 0$$

$${\sum }_{i ∈ N , j ∈ N , i \neq j} {α}_{ij} = 0$$

Note that these sums go over N and not A since the constraints are over all of the parameters. Now eliminate parameters as usual, for example substituting

$${γ}_{jj} = - {\sum }_{k ∈ N ∖ j} {γ}_{kj} for each j ∈ N$$

$$log {B}_{1} = - {\sum }_{k ∈ N ∖ 1} log {B}_{k}$$

$${α}_{12} = - {\sum }_{i \neq 1 , j \neq 2} {α}_{ij}$$

into the system. Perform this construction for each store-week in the historical data, and then apply least-squares regression to obtain estimates for the γᵢⱼ and αᵢⱼ that remain after performing the above substitutions.

It is possible to estimate the original, unmodified Scan*Pro model with this same technique of cancellation by, as disclosed above, using the disclosed ratio-of-pairs method and the geometric-mean method. In Scan*Pro, the seasonality parameter takes the place of D_{T}(p, A) and the denominator of sᵢ(p, A) and can be canceled out in similar fashion. After applying the cancellation technique, note that the resulting equations are exactly the same as when applying the cancellation technique to sᵢ(p, A). Mathematically, this suggests that the estimates for the lower layer 308 won't be different from the estimates derived from just using Scan*Pro itself. Therefore, as a practical matter, if a retailer has already implemented estimation of unmodified Scan*Pro, the retailer can just re-use these estimates for the lower layer 308 instead of coding a new estimation for the lower layer, possibly avoiding a great deal of work. Note this is an unusual advantage, as usually when replacing an existing model with a new one, significant coding effort is required.

### Estimating Top Layer Model 306

In a separate estimation, embodiments also have, in each store-week,

$${\sum }_{j ∈ A} {q}_{j} = M α ( {U}_{T} ( p , A ) ) .$$

where

$$α ( x ) = \frac{x}{x + 1} .$$

This choice of α allows interpreting Mα(U_{T}(p, A)) as the sum of demand from a standard MNL model. Therefore, embodiments can use any standard MNL estimation procedure to estimate M and the parameters of U_{T}. Note that only the sum of demand matters here, and as a matter of practicality of estimation, replace the γ_{T}_{ⱼ} with just a single γ_{T} per store whose estimate will be an average over all of the individual γ_{T}_{ⱼ} at the store. This is likely to be good enough if enough data is available for the estimation.

### Use Geometric Mean Estimation for Practicality

The above estimation procedure can become impractical because it forms quotients of all pairs of items in the assortment in each store-week. Assortments at many retailers can be quite large, up to even thousands of items, and the number of pairs then grows too large for practicality. Cancellation using the geometric mean avoids this problem, though at the expense of more notation in the explanation. From that standpoint, cancellation using ratios of pairs is easier to understand. The following is a partial illustration of the geometric-mean technique:

For each item i, form the geometric mean of the sⱼ(p, A), j≠i:

$$\begin{matrix}{G}_{i} = {( {\prod }_{j ∈ A ∖ i} {D}_{T} ( p , A ) {s}_{j} ( p , A ) )}^{\frac{1}{\vert A \vert - 1}} \\ = {( {\prod }_{j ∈ A ∖ i} {u}_{j} ( p , A ) )}^{\frac{1}{\vert A \vert - 1}} \cdot {D}_{T} ( p , A ) \cdot denominatorof {s}_{i} ( p , A )\end{matrix}$$

since D_{T}(p, A) and the denominator are common to all the factors in the geometric mean and therefore can come out of the geometric mean. Since they do come out of the geometric mean, dividing D_{T}(p, A)sᵢ(p, A) by Gᵢ then cancels out D_{T}(p, A) and the denominator of sᵢ(p, A) just as with taking pairs of ratios but without the blowup of taking pairs, giving the geometric-mean analogue of taking ratios of pairs:

$$\begin{matrix}\frac{{q}_{m}}{{( {\prod }_{k ∈ A , k \neq m} {q}_{k} )}^{\frac{1}{\vert A \vert - 1}}} = \frac{{D}_{T} ( p , A ) {s}_{i} ( p , A )}{{G}_{i}} \\ = \frac{{u}_{i} ( p , A )}{{( {\prod }_{j ∈ A \backslash i} {u}_{j} ( p , A ) )}^{\frac{1}{\vert A \vert - 1}}}\end{matrix}$$

What factors are in the denominator?

### Geometric Mean of Base Demands

$${( {\prod }_{j ∈ A ∖ i} {B}_{j} )}^{\frac{1}{\vert A \vert - 1}}$$

Geometric means involving prices and cross-price elasticities. Each uⱼ(p, A) contributes

$${p}_{k}^{{γ}_{j k}} , j ∈ A ∖ i ,$$

so gathering together by k gives:

$${\prod }_{k ∈ A} {p}_{k}^{\frac{1}{\vert A \vert - 1} {\sum }_{j ∈ A ∖ i} {γ}_{j k}}$$

These factors combine with the price factors in the numerator to give:

$${\prod }_{k ∈ A} {p}_{k}^{{γ}_{i k} - \frac{1}{\vert A \vert - 1} {\sum }_{j ∈ A ∖ i} {γ}_{j k}}$$

Geometric means of the alphas:

$${( {\prod }_{j ∈ A ∖ i} {\prod }_{k ∈ A ∖ j} {α}_{j k} )}^{\frac{1}{\vert A \vert - 1}}$$

The entirety of the alpha factors, combining numerator and denominator, is then

$$\frac{{\prod }_{k ∈ A ∖ i} {α}_{j k}}{{( {\prod }_{j ∈ A ∖ i} {\prod }_{k ∈ A ∖ j} {α}_{j k} )}^{\frac{1}{\vert A \vert - 1}}}$$

In summary, embodiments can take logs and obtain a log-linear expression just as with ratios of pairs. Note that the same constraints are still necessary for avoiding multiple solutions.

### Practical Calculation of Cross-Price Elasticities

As disclosed above, the cross-price elasticities γᵢⱼ in lower-layer model 308 originate from the standard version of the Scan*Pro model. In practice, estimating these γᵢⱼ can present difficulties:
The number of γᵢⱼ grows as roughly the square of the number of possible items in the assortment since each pair of products (i, j), i≠j, has an associated γᵢⱼ. Itis common in many areas of retailing to have assortments numbering in the thousands, which therefore means millions of γᵢⱼ, which is a computational burden during estimation.
With so many independent parameters, overfitting is likely.
Business Interpretation of the resulting estimates for the γᵢⱼ can be difficult. Even when statistically insignificant ones are removed, a large number may remain, and it is confusing and time consuming for any business analyst to go through all of them to validate them or obtain business insight. Experience also shows that many γᵢⱼ will have the wrong sign, further complicating interpretation. For the formulation in embodiments, the γᵢⱼ should be positive but in practice a great many will not be if the γᵢⱼ are estimated directly.

Various known techniques are used to avoid these problems, including:
Lasso regression is a general technique for reducing the number of non-zero estimated parameters. However, it may not help with business interpretability or with incorrect signs, and it requires setting lasso coefficients for estimation to proceed.
Constrained regression, such as constraining the γᵢⱼ to be non-negative, can improve interpretability. However, constrained regression requires more computing power.
Frequently, retailers have additional information indicating how similar two items are to each other. Such information allows reformulating the γᵢⱼ to greatly reduce the number of estimated parameters, which aids business interpretability and reduces computing effort. In practice this approach also has a track record of helping get the correct signs even without using constrained regression, further increasing interpretability.

Estimation of the lower-layer model 308 can employ the first two techniques, lasso or constrained regression, in embodiments. The following illustrates that the last technique is also straightforward to apply to the lower-layer model 308. In essence, when applying the technique, the resulting model can be estimated as though embodiments are still working with Scan*Pro itself because the form of the utility uᵢ(pₜ) remains the same and therefore the estimation techniques shown our other documents still apply. Examples are below.

### Similarity-Based γᵢⱼ

If two items i and j are similar, meaning customers shopping for one might to some degree substitute the other, then raising or lower the price of one will affect the sales of the other based on the degree of similarity. Two items that are extremely similar may, for example, divide the market between them and raising the price of j will simply drive customers to purchase i instead. That is, γᵢⱼ will have a larger positive value than it might otherwise have if the items were less similar. Having values SIMᵢⱼ indicating how similar items i and j can allow the entire set of γᵢⱼ to be reduced to:

$${γ}_{i j} = γ \cdot {SIM}_{ij} , i \neq j .$$

That is, there is just a single parameter γ to estimate if SIMᵢⱼ is available. It is no longer necessary for the business analyst to examine and interpret possibly hundreds or even thousands of separate γᵢⱼ. Moreover, SIMᵢⱼ is generally comprehensible to business analysts, aiding further in business interpretability, especially because in practice, it is very likely that γ will have the correct sign (positive).

Some examples of external sources of SIMᵢⱼ used in practice include:
Image-based similarity. Machine-learning techniques for handling images can calculate SIMᵢⱼ using pictures of items i and j and determining how similar the pictures are.
Attribute-based similarity. Many retailers have already classified their merchandise according to attributes. A clothing retailer, for example, might use color, silhouette, and sleeve length, among numerous other attributes, to classify clothing. Given a pair of items i and j, calculate SIMᵢⱼ as simply the fraction of attributes where the attribute values for i agree with the attribute values for j. If they agree on 3 out of 5 attributes, the similarity is 3/5. Attribute-based similarity is popular because retailers find it straightforward to interpret.

As mentioned above, the point is that the form of the utility uᵢ(pᵢₜ) remains the same after substituting γᵢⱼ=γ·SIMᵢⱼ, i≠j:

$${u}_{i} ( {p}_{t} ) = {B}_{i} {p}_{i t}^{{γ}_{i i}} {\prod }_{i \neq j} {( {p}_{j t}^{{SIM}_{i j}} )}^{γ}$$

Note that

$${p}_{j t}^{{SIM}_{i j}}$$

is still just a number, so

$${( {p}_{j t}^{{SIM}_{i j}} )}^{γ}$$

is just raising that number to the γ, and thus the mathematical form of uᵢ(pₜ) is the same as it was when just using Scan*Pro directly.

### Second Form of Employing Attributes

The following is a more involved illustration, but still based on the same principle of maintaining the mathematical form of the utility uᵢ(pᵢₜ).

The model disclosed in Rooderkerk et al., “Optimizing Retail Assortments”, Marketing Science 32(5): 699-715 (September 2013) proposes a different way of using attributes to vastly reduce the number of estimated cross effects. It is still compatible with embodiments of the invention. Suppose G is the set of attributes. For example, G might be Color, Neckline, and Sleeve Length. Then express γᵢⱼ as

$${γ}_{i j} = {\sum }_{g ∈ G} {γ}_{g} {SIM}_{g i j}$$

The variables SIM_{gij} are values which indicate the similarity of item i and item j only along the attribute g, as opposed to the entire similarity SIMᵢⱼ. In Rooderkerk et al., SIM_{gij} can also vary by week and store, but this does not affect compatibility with embodiments. The γ_{g} are estimated parameters, one for each attribute, instead of the single γ that we had with SIMᵢⱼ. Then the utility becomes:

$${u}_{i} ( {p}_{t} ) = {B}_{i} {p}_{i t}^{{γ}_{i i}} {\prod }_{i \neq j} {\prod }_{g ∈ G} {( {p}_{j t}^{{SIM}_{g i j}} )}^{{γ}_{g}}$$

As before, the

$${p}_{j t}^{{SIM}_{gij}}$$

are just numbers, and so the mathematical form of the utility is still the same.

### Example Cloud Infrastructure

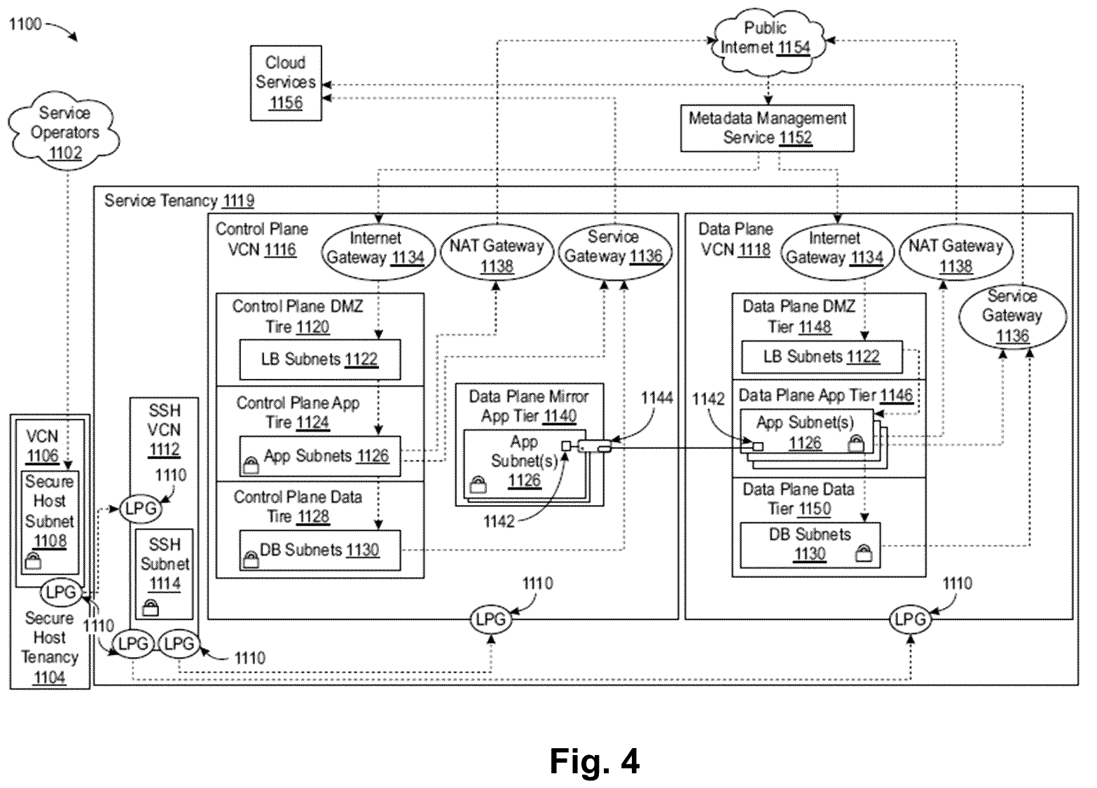

FIGS. 4-7 illustrate an example cloud infrastructure that can implement system 100 that can include demand transference system 10 of FIG. 1 in accordance to embodiments. The use of the cloud infrastructure, as opposed to an on-premise implementation, allows for data 302 and 304 to be receive from many different entities that are interacting with the application of interest, which enhances the accuracy of models 306, 308.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 4 is a block diagram 1100 illustrating an example pattern of an Iaas architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

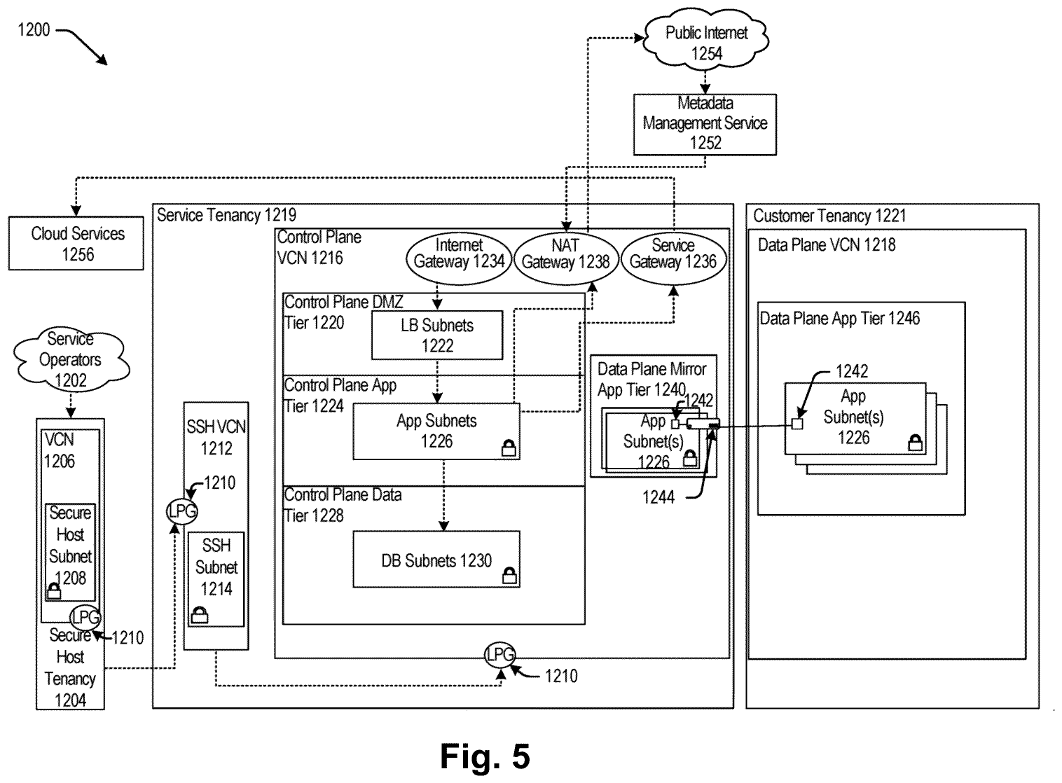

FIG. 5 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

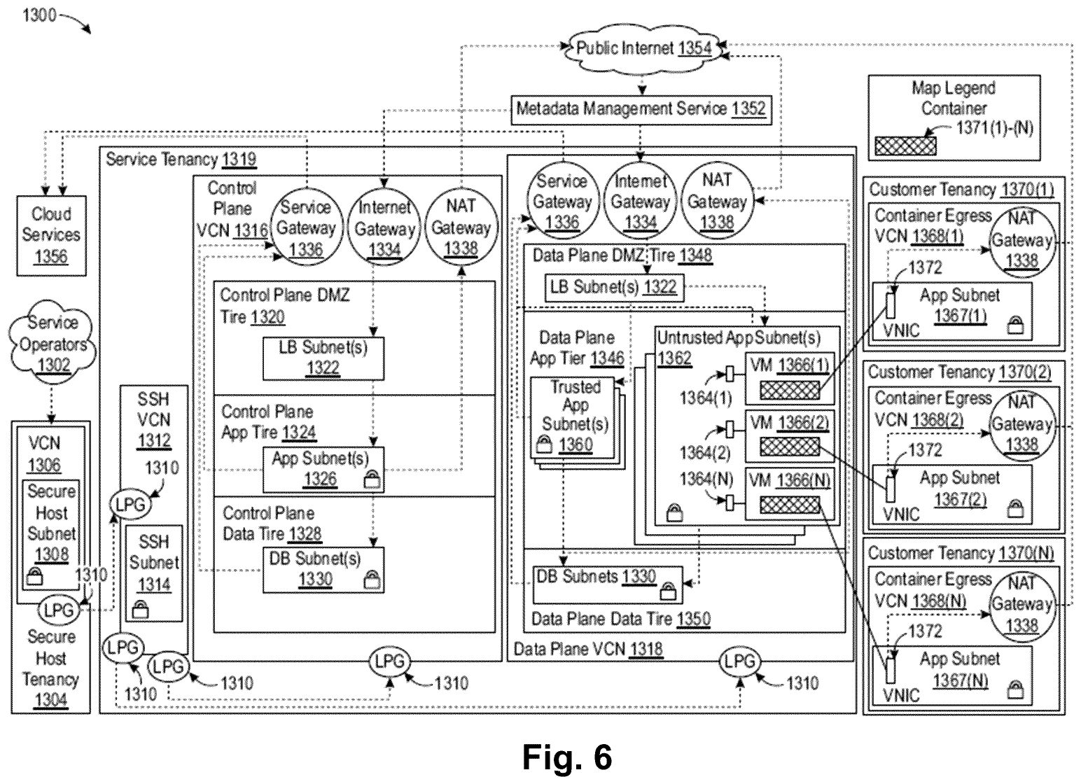

FIG. 6 is a block diagram 1300 illustrating another example pattern of an IaaS architecture, according to at least one embodiment. Service operators 1302 (e.g., service operators 1102) can be communicatively coupled to a secure host tenancy 1304 (e.g., the secure host tenancy 1104) that can include a virtual cloud network (VCN) 1306 (e.g., the VCN 1106) and a secure host subnet 1308 (e.g., the secure host subnet 1108). The VCN 1306 can include an LPG 1310 (e.g., the LPG 1110) that can be communicatively coupled to an SSH VCN 1312 (e.g., the SSH VCN 1112) via an LPG 1310 contained in the SSH VCN 1312. The SSH VCN 1312 can include an SSH subnet 1314 (e.g., the SSH subnet 1114), and the SSH VCN 1312 can be communicatively coupled to a control plane VCN 1316 (e.g., the control plane VCN 1116) via an LPG 1310 contained in the control plane VCN 1316 and to a data plane VCN 1318 (e.g., the data plane 1118) via an LPG 1310 contained in the data plane VCN 1318. The control plane VCN 1316 and the data plane VCN 1318 can be contained in a service tenancy 1319 (e.g., the service tenancy 1119).

The control plane VCN 1316 can include a control plane DMZ tier 1320 (e.g. the control plane DMZ tier 1120) that can include load balancer (“LB”) subnet(s) 1322 (e.g., LB subnet(s) 1122), a control plane app tier 1324 (e.g., the control plane app tier 1124) that can include app subnet(s) 1326 (e.g., similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g., the service gateway) and a network address translation (NAT) gateway 1338 (e.g., the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g., the data plane DMZ tier 1148), and a data plane data tier 1350 (e.g., the data plane data tier 1150). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

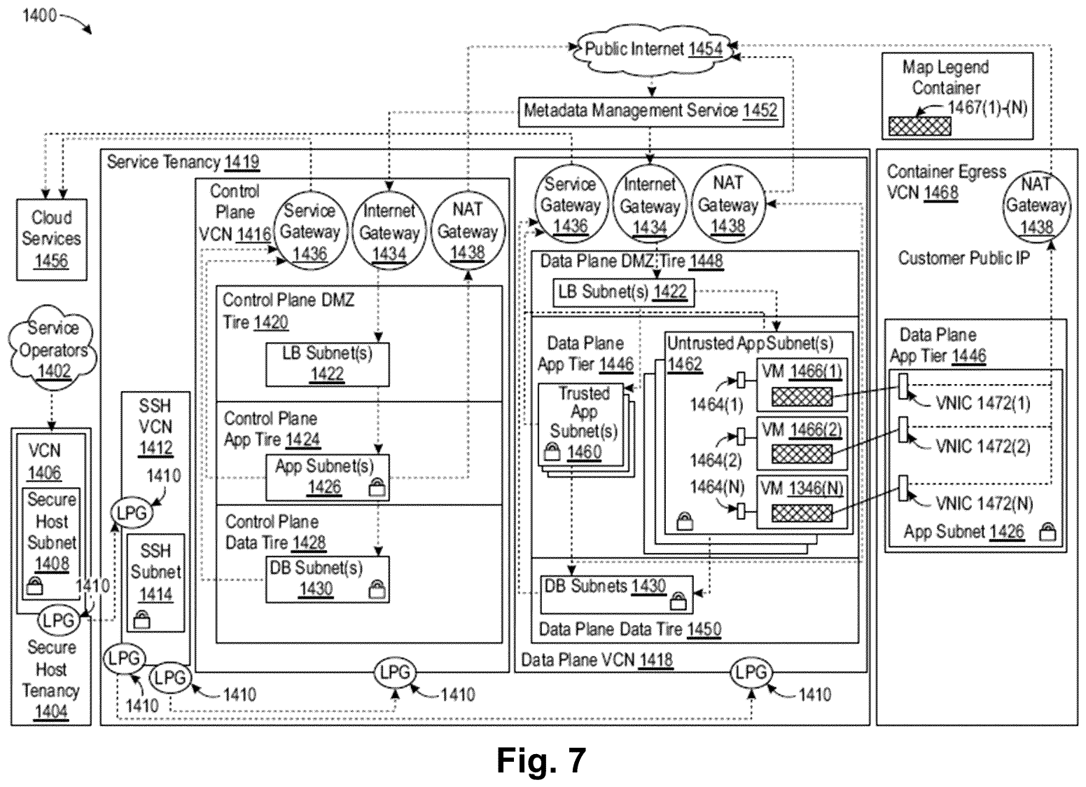

FIG. 7 is a block diagram 1400 illustrating another example pattern of an IaaS architecture, according to at least one embodiment. Service operators 1402 (e.g., service operators 1102) can be communicatively coupled to a secure host tenancy 1404 (e.g., the secure host tenancy 1104) that can include a virtual cloud network (“VCN”) 1406 (e.g., the VCN 1106) and a secure host subnet 1408 (e.g. the secure host subnet 1108). The VCN 1406 can include an LPG 1410 (e.g., the LPG 1110) that can be communicatively coupled to an SSH VCN 1412 (e.g., the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g., the control plane VCN 1116) via an LPG 1410 contained in the control plane VCN 1416 and to a data plane VCN 1418 (e.g., the data plane 1118) via an LPG 1410 contained in the data plane VCN 1418. The control plane VCN 1416 and the data plane VCN 1418 can be contained in a service tenancy 1419 (e.g., the service tenancy 1119).

The control plane VCN 1416 can include a control plane DMZ tier 1420 (e.g., the control plane DMZ tier 1120) that can include LB subnet(s) 1422 (e.g. LB subnet(s) 1122), a control plane app tier 1424 (e.g., the control plane app tier 1124) that can include app subnet(s) 1426 (e.g., app subnet(s) 1126), a control plane data tier 1428 (e.g., the control plane data tier 1128) that can include DB subnet(s) 1430 (e.g., DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 5) and a network address translation (NAT) gateway 1438 (e.g., the NAT gateway 1138). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 may be considered an exception to the pattern illustrated by the architecture of block diagram 1300 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of determining demand transference for an item assortment of a retailer, the method comprising:
receiving historical sales data for a category of items corresponding to the retailer;
receiving hierarchy data for the category of items corresponding to the retailer;
based on the historical sales data and the hierarchy data, estimating first variables of a multinomial logit (MNL) model; and
based on the historical sales data and the hierarchy data, estimating second variables of a log linear retail sales model.

2. The method of claim 1, wherein the estimating second variables of the log linear retail sales model comprises determining ratio of pairs.

3. The method of claim 1, wherein the estimating second variables of the log linear retail sales model comprises determining geometric means.

4. The method of claim 1, wherein the log linear retail sales model is derived from a Scan*Pro model.

5. The method of claim 1, wherein the log linear retail sales model comprises a Scan*Pro model, and the estimating second variables of the log linear retail sales model comprises using a determining ratio of pairs estimation or a determining geometric means estimation.

6. The method of claim 1, wherein the MNL model is non-nested.

7. The method of claim 1, wherein the estimated first variables of the MNL model comprise M, γ_{Tj}, and B_{Tj}, where the set of all potential customers who might consider purchasing an item by [symbol] , where M=| [symbol] | is a size of the set, γ_{Tj} is a price elasticity as it relates the price of an item to its sales, and B_{Tj} is a base utility of an item.

8. The method of claim 1, wherein the estimated second variables of the log linear retail sales model comprise Bᵢ, γᵢⱼ, and αᵢⱼ, where Bᵢ is a base demand of item i, γᵢⱼ, i≠j is a cross-price elasticity between item i and item j, and αᵢⱼ, is a assortment effect of item j on item i.

9. The method of claim 1, further comprising:
generating a sales forecast for the category of items using the estimated first variables of the MNL model and the estimated second variables of the log linear retail sales model.

10. A non-transitory computer readable medium having instructions stored thereon that, when executed by one or more processors, cause the processors to determine demand transference for an item assortment of a retailer, the determining demand transference comprising:
receiving historical sales data for a category of items corresponding to the retailer;
receiving hierarchy data for the category of items corresponding to the retailer;
based on the historical sales data and the hierarchy data, estimating first variables of a multinomial logit (MNL) model; and
based on the historical sales data and the hierarchy data, estimating second variables of a log linear retail sales model.

11. The computer readable medium of claim 10, wherein the estimating second variables of the log linear retail sales model comprises determining ratio of pairs.

12. The computer readable medium of claim 10, wherein the estimating second variables of the log linear retail sales model comprises determining geometric means.

13. The computer readable medium of claim 10, wherein the log linear retail sales model is derived from a Scan*Pro model.

14. The computer readable medium of claim 10, wherein the log linear retail sales model comprises a Scan*Pro model, and the estimating second variables of the log linear retail sales model comprises using a determining ratio of pairs estimation or a determining geometric means estimation.

15. The computer readable medium of claim 10, wherein the MNL model is non-nested.

16. The computer readable medium of claim 10, wherein the estimated first variables of the MNL model comprise M, γ_{Tj}, and B_{Tj}, where the set of all potential customers who might consider purchasing an item by [symbol] , where M=[ [symbol] ] is a size of the set, γ_{Tj} is a price elasticity as it relates the price of an item to its sales, and B_{Tj} is a base utility of an item.

17. The computer readable medium of claim 10, wherein the estimated second variables of the log linear retail sales model comprise Bᵢ, γᵢⱼ, and αᵢⱼ, where Bᵢ is a base demand of item i, γᵢⱼ, i≠j is a cross-price elasticity between item i and item j, and αᵢⱼ, is a assortment effect of item j on item i.

18. The computer readable medium of claim 10, the determining demand transference further comprising:
generating a sales forecast for the category of items using the estimated first variables of the MNL model and the estimated second variables of the log linear retail sales model.

19. A sales forecast system for determining demand transference for an item assortment of a retailer, the system comprising:
a first database storing historical sales data for a category of items corresponding to the retailer;
a second database storing hierarchy data for the category of items corresponding to the retailer;
a multinomial logit (MNL) model;
a log linear retail sales model;
one or more processors configured to:
based on the historical sales data and the hierarchy data, estimate first variables of the multinomial logit (MNL) model; and
based on the historical sales data and the hierarchy data, estimate second variables of the log linear retail sales model.

20. The sales forecast system of claim 19, the one or more processors further configured to:
generate a sales forecast for the category of items using the estimated first variables of the MNL model and the estimated second variables of the log linear retail sales model.
